(19) United States
(12) Patent Application Publication
(10) Pub. No.: US 2024/0192316 A1
(43) Pub. Date: Jun. 13, 2024

(54) METHOD FOR CALIBRATING SENSOR INFORMATION FROM A VEHICLE, AND VEHICLE ASSISTANCE SYSTEM

(71) Applicants: Continental Autonomous Mobility Germany GmbH, Ingolstadt (DE); Volkswagen AG, Wolfsburg (DE)

(72) Inventors: Axel ROTH, Nürnberg (DE); Heiko Gustav KURZ, Hannover (DE); Dominik VOCK, Jembke (DE); Thorsten BAGDONAT, Braunschweig (DE)

(21) Appl. No.: 18/554,930

(22) PCT Filed: Apr. 7, 2022
(86) PCT No.: PCT/EP2022/059207

§ 371 Date: Oct. 11, 2023

(30) Foreign Application Priority Data
Apr. 12, 2021 (DE) 102021109010.5
May 20, 2021 (DE) 102021113111.1

(51) Int. Cl. G01S 7/40; G01S 7/497; G01S 13/86; G01S 13/931; G01S 17/86; G01S 17/931

(52) U.S. Cl. CPC G01S 7/40; G01S 7/497; G01S 13/867; G01S 13/931; G01S 17/86; G01S 17/931; G01S 2013/9323

(57) ABSTRACT

A method for online calibration of sensor information from a vehicle, wherein the vehicle has at least one sensor of a first sensor type and at least one sensor of a second sensor type which is different from the first sensor type.

### FIELD

The invention relates to a method for the online calibration of sensor information from a vehicle as well as a driver assistance system.

### BACKGROUND

For autonomous driving, it is indispensable that the perception of the environment is as reliable as possible. In this context, the environment is detected by means of sensors of different sensor types, such as at least one radar sensor, one or more cameras and preferably also at least one LIDAR sensor. A holistic 360° 3D detection of the environment is preferred so that all static and dynamic objects in the vehicle environment can be detected.

In order to ensure a reliable detection of the environment, a precise calibration of the sensors with respect to one another is required in particular. In this context, permanent monitoring of the calibration state of the sensor systems, as well as—if necessary—a recalibration while driving is indispensable for highly automated driving functions since otherwise a failure of the autonomous driving function would result.

In known methods, sensors are calibrated individually relative to a fixed point of the vehicle but a calibration is not made regarding the entire set of sensors relative to one another. This has the disadvantage that it is often not possible to achieve the precision required for automatic driving functions.

### SUMMARY

Based on this, it is the object of the present disclosure to provide a method for calibrating sensor information from a vehicle that renders possible a reliable and highly accurate online sensor calibration, i.e. a calibration of sensor information of different sensor types relative to one another during a movement of the vehicle.

According to a first aspect, the present disclosure relates to a method for calibrating sensor information of a vehicle. The vehicle comprises at least one sensor of a first sensor type and at least one sensor of a second sensor type which is different from the first sensor type. Here, “different sensor type” means that the sensors use different methods or technologies for detecting the environment, for example detecting the environment on the basis of different types of electromagnetic waves (radar, lidar, ultrasound, visible light, etc.).

The method comprises the following steps:

First, the environment is detected during the vehicle movement by at least one sensor of the first sensor type. In this connection, first sensor information is provided by this sensor of the first sensor type.

Similarly, the environment is detected during the movement of the vehicle by at least one sensor of the second sensor type. In this connection, second sensor information is provided by this sensor of the second sensor type. The first and second sensor information can be detected simultaneously or at least at times with a temporal overlap. It is understood that the first and second sensor information relate at least in part to the same environment area and thus have at least in part the same coverage.

Subsequently, a first three-dimensional representation of environment information is generated from the first sensor information. The first three-dimensional representation of environment information is in particular a 3D point cloud that represents the vehicle surroundings on the basis of a plurality of points in the three-dimensional space.

In addition, a second three-dimensional representation of environment information is generated from the second sensor information. The second three-dimensional representation of environment information is again in particular a 3D point cloud that reflects the vehicle surroundings on the basis of a plurality of points in the three-dimensional space.

Subsequently, the first and second three-dimensional representations of environment information or information derived therefrom are compared. “Comparing” in the sense of the present disclosure is in particular understood to mean that the first and second three-dimensional representations are related to one another in order to be able to check the congruence of the first and second three-dimensional representations of environment information. In particular, this can mean determining areas that correspond to one another in the first and second three-dimensional representations of environment information. “Information derived therefrom” is understood to mean any information that can be obtained from the first and second three-dimensional representations by any kind of data processing, for example by data reduction, filtering, etc.

Then, differences between the first and second three-dimensional representations of environment information or information derived therefrom are determined. In particular, it can be checked whether there is, taken altogether, a difference between the plurality of corresponding areas in the first and second three-dimensional representations, which difference can be attributed to improper calibration of the sensors. For example, an offset of corresponding areas in the first and second three-dimensional representations, which offset increases with distance from the vehicle, can result from an improper calibration in the roll, pitch, and/or yaw angle of a sensor.

After determining the differences, corrective information on calibration parameters of at least one sensor is calculated on the basis of the determined differences. The corrective information can provide in particular an indication of how the calibration of one or more sensors needs to be changed to achieve an improved congruence accuracy of the first and second three-dimensional representations of environment information.

Finally, the sensors of the vehicle are calibrated relative to one another on the basis of the calculated corrective information. The calibration of the sensors comprises in particular a software-based calibration, i.e. the sensor information provided by one or more sensors is adapted on the basis of the corrective information in such a way that an improved congruence of the first and second three-dimensional representations of environment information is achieved.

It is understood that it is also possible to calibrate sensors of more than two different sensor types on the basis of the proposed method.

The technical advantage of the proposed method is that by converting multiple different sensor information into a three-dimensional representation of environment information, the sensor information becomes comparable with one another, as a result of which online calibration of the sensors on the basis of surroundings information obtained during the vehicle travel becomes possible. As a result, a highly accurate calibration of the sensors can be achieved, which is necessary for a secure and precise surroundings detection for autonomous driving functions of the vehicle.

According to an exemplary embodiment, the first and second three-dimensional representations of environment information are discrete-time information. In other words, the sensors do not provide continuous-time information but instead provide environment information at discrete points in time, such as at a specific clock rate. Prior to comparing the first and second three-dimensional representations of environment information or information derived therefrom, the information is synchronized with respect to one another with regard to time. It is thus possible to reduce congruence inaccuracies between the first and second three-dimensional representations of environment information, which inaccuracies result from a temporal offset of the environment information due to the different sensors, for example due to different clock rates or different detection times.

In the event that it is not possible to synchronize the first and second three-dimensional representations of environment information with regard to time, interpolation of information between two time steps of the discrete-time information can be carried out prior to comparing the first and second three-dimensional representations of environment information or information derived therefrom. Thus, intermediate values of sensor information or three-dimensional representations of environment information can be obtained between two successive time steps, by means of which an improved congruence accuracy can be achieved.

According to an exemplary embodiment, respective first and second three-dimensional representations of environment information which reflect the vehicle environment at the same point in time, are compared with one another and differences between these first and second three-dimensional representations of environment information are used to calculate the corrective information. In particular, it is checked whether it is possible, among the plurality of differences that exist between corresponding information in the first and second three-dimensional representations of environment information, to determine such differences that are due to a calibration error of one or more sensors. When such differences are determined, an attempt can be made to adjust the calibration of one or more sensors in such a way that the differences are reduced, i.e. the congruence accuracy of the first and second three-dimensional representations of environment information is increased.

According to an exemplary embodiment, the corrective information on calibration parameters is calculated iteratively, namely in such a way that in several iteration steps at least one first and second three-dimensional representations of environment information, which reflect the vehicle surroundings at the same point in time, are compared with one another, corrective information is calculated, and after the application of the corrective information to the calibration parameters of at least one sensor, information about the congruence of the first and second three-dimensional representations of environment information is determined. As a result, the calibration of the sensors can be improved iteratively.

According to an exemplary embodiment, the corrective information is iteratively changed in the successive iteration steps in such a way that the congruence error between the first and second three-dimensional representations of environment information is reduced. After determining corrective information in an iteration step, for example, the corrective information is applied, thereby changing the sensor calibration. This preferably results in a modified first and/or second three-dimensional representation of environment information, which is checked for congruence. This cycle is run several times until a termination criterion is met. Thus, the sensor calibration can be improved iteratively.

According to an exemplary embodiment, a minimization method or an optimization method is used to reduce the congruence error. An example for such method is the iterative closest point algorithm. When carrying out the algorithm, an attempt is made, for example, to match the first and second three-dimensional representations of environment information as closely as possible by means of rotation and translation. For example, points that correspond with one another, of the first and second three-dimensional representations of environment information are determined and then e.g. the sum of the squares of the distances over all these pairs of points is formed. Thus, a quality criterion regarding the correspondence between the three-dimensional representations of environment information and/or the 3D point clouds is obtained. The goal of the algorithm is to minimize this quality criterion by changing the transformation parameters (i.e. parameters for rotation and translation). As a result, the congruence of the three-dimensional representations of environment information obtained by different sensors can be successively improved.

According to an exemplary embodiment, the corrective information on calibration parameters is calculated by means of a plurality of first and second three-dimensional representations of environment information determined at different points in time, namely in such a way that a plurality of pairs of first and second three-dimensional representations of environment information—the environment information of a pair each representing the vehicle surroundings at the same point in time—is compared with one another and corrective information is calculated. By comparing first and second three-dimensional representations of environment information over multiple points in time, the accuracy of the sensor calibration can be further increased.

According to an exemplary embodiment, the sensor of the first sensor type is a camera. In particular, the camera can be designed to generate two-dimensional images. Multiple sensors of the first sensor type can also be provided to detect a larger area of the surroundings of the vehicle. In particular, the sensors of the first sensor type can be used to generate a 360° representation of the surroundings, i.e. an all-round view in a horizontal plane.

According to an exemplary embodiment, the camera is a monocular camera and from the image information provided by the camera, three-dimensional representations of environment information are calculated from single images or a sequence of temporally consecutive two-dimensional images. For example, a structure-from-motion method, a shape-from-focus method, or a shape-from-shading method can be used here. Alternatively, depth estimation can also be carried out by means of neural networks. This allows depth information to be obtained on the two-dimensional image information from the camera, which is used to generate three-dimensional representations of environment information. Structure-from-motion methods usually assume a static environment.

Alternatively, one or more stereo cameras can be used to obtain depth information on the two-dimensional image information.

According to an exemplary embodiment, a segmentation of moving objects contained in the image information and an estimation of three-dimensional structure and relative movements of the segmented objects and the stationary surroundings are carried out on the basis of a sequence of temporally successive image information from at least one camera, in particular two-dimensional image information, for example by means of the method from patent application DE 10 2019 208 216 A1. This allows segmentation and structure information to be determined with high accuracy even in dynamic environments. The determined information on the relative movements of the surroundings and the moving objects can advantageously be incorporated into the synchronization of the three-dimensional representations of all objects, or interpolation between two time steps, which leads to higher accuracy in the determination of the corrective information for the calibration parameters.

According to an exemplary embodiment, the sensor of the second sensor type is a radar sensor or a LIDAR sensor.

According to an exemplary embodiment, moving objects are filtered out of the first and second three-dimensional representations of environment information so that the corrective information is calculated exclusively on the basis of stationary objects. By filtering out the moving objects, the accuracy of the sensor calibration can be increased because, in the case of stationary objects, the difference between the first and second three-dimensional representations of environment information can be used to directly infer the calibration inaccuracies between the sensors.

According to another exemplary embodiment, the corrective information is calculated on the basis of a comparison of first and second three-dimensional representations of environment information containing only stationary objects and on the basis of a comparison of first and second three-dimensional representations of environment information containing only moving objects. Therefore, in addition to stationary objects, moving objects can also be used to calculate corrective information for the sensor calibration. However, movement information, for example the trajectory or velocity, should preferably be known for the moving objects in order to be able to compensate for the movement of the objects when calculating the corrective information.

According to a further aspect, the present disclosure relates to a driver assistance system for a vehicle. The driver assistance system includes a sensor of a first sensor type and at least one sensor of a second sensor type that is different from the first sensor type. The driver assistance system is configured to carry out the following steps:
detecting the environment during the vehicle movement by at least one sensor of the first sensor type and providing first sensor information by this sensor of the first sensor type;
detecting the environment during the vehicle movement by at least one sensor of the second sensor type and providing second sensor information by this sensor of the second sensor type;
creating a first three-dimensional representation of environment information from the first sensor information;
creating a second three-dimensional representation of environment information from the second sensor information;
comparing the first and second three-dimensional representations of environment information or information derived therefrom;
determining differences between the first and second three-dimensional representations of environment information or information derived therefrom;
calculating corrective information on calibration parameters of at least one sensor on the basis of the determined differences;
calibrating the sensors of the vehicle relative to one another on the basis of the calculated corrective information.

The term “three-dimensional representation of environment information” means any representation of environment information in a three-dimensional coordinate system, such as a discrete spatial representation of object ranges in the three-dimensional space.

The term “3D point cloud” as used in the present disclosure is understood to mean a set of points in the three-dimensional space, each point indicating that there is an object section at the location at which the point is found in the three-dimensional space.

The term “sensor type” as used in the present disclosure is understood to mean a sensor type that determines environment information by means of a predetermined detection principle. Sensor types can be, for example, cameras, radar sensors, LIDAR sensors, ultrasonic sensors, etc.

In the sense of the present disclosure, the expressions “approximately”, “substantially” or “about” mean deviations from the respective exact value by +/−10%, preferably by +/−5% and/or deviations in the form of changes that are insignificant for the function.

Further developments, advantages and possible uses of the invention also result from the following description of exemplary embodiments and from the drawings. In this connection, all the features described and/or illustrated are in principle the subject matter of the invention, either individually or in any combination, irrespective of their summary in the claims or the back-reference thereof. The contents of the claims are also made a part of the description.

### BRIEF DESCRIPTION OF THE DRAWINGS

The present disclosure will be explained in more detail below with reference to the drawings using exemplary embodiments. In these drawings:

FIG. 1 shows by way of example a schematic representation of a vehicle with a driver assistance system comprising a plurality of sensors of different sensor types for detecting the environment of the vehicle;

FIG. 2 shows by way of example a flow chart for illustrating method steps for calibrating sensor information of a camera and sensor information of a radar and/or LIDAR; and

FIG. 3 shows by way of example a schematic representation of the method steps for the online calibration of sensor information of different sensor types.

### DETAILED DESCRIPTION

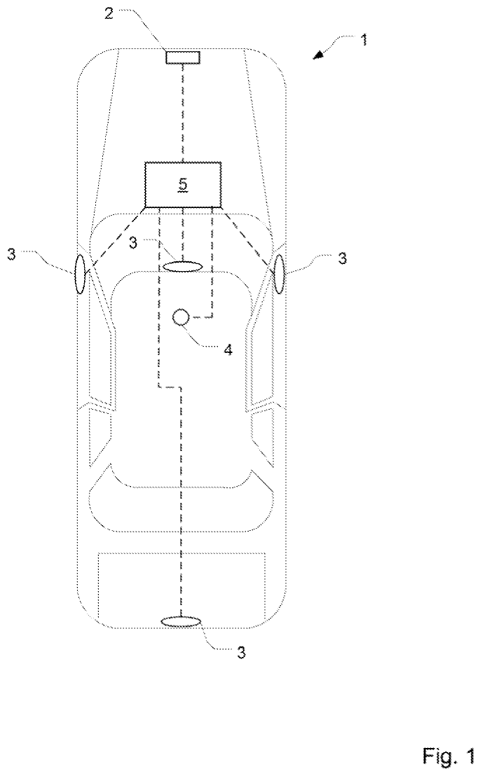

FIG. 1 shows, by way of example and schematically, a vehicle 1 with a driver assistance system which renders possible a detection of the environment by means of a plurality of sensors 2, 3, 4 of different sensor types. At least some of the sensors 2, 3, 4 render possible all-round detection of the environment (360° detection of the environment).

The vehicle 1 comprises in particular at least one sensor 2 of a first sensor type, which is a radar sensor. The first sensor type is thus based on the radar principle. The sensor 2 can be provided, for example, in the front area of the vehicle. It is understood that a plurality of sensors 2 of the first sensor type can be provided so as to be distributed around the vehicle 1, for example in the front area, in the rear area and/or in the side areas of the vehicle 1. The at least one sensor 2 of the first sensor type generates first sensor information. This is, for example, the raw information provided by a radar sensor. From this first sensor information, a first three-dimensional representation of environment information is generated. In particular, this can be a 3D point cloud. In the event that multiple sensors 2 of the first sensor type are used, the first three-dimensional representation of environment information can be generated on the basis of sensor information from multiple or all of these sensors 2.

Furthermore, the vehicle 1 comprises at least one sensor 3 of a second sensor type, which is a camera. The second sensor type is thus of the “camera” type, i.e. an image capturing sensor. The sensor 3 can be provided, for example, in the windshield area of the vehicle 1. It is understood that a plurality of sensors 3 of the second sensor type can be provided so as to be distributed around the vehicle 1, for example in the front area, in the rear area and/or in the side areas of the vehicle 1. The at least one sensor 3 of the second sensor type generates second sensor information. This is, for example, image information provided by a camera. The camera can provide two-dimensional image information of the environment, i.e. the image information does not contain depth information. In this event, the second sensor information can be processed further in such a way that depth information on the image information is obtained from the change in the image information in successive images of an image sequence. For this purpose, methods known to a person skilled in the art can be used which generate spatial correlations from two-dimensional image sequences. Examples are the structure-from-motion method, the shape-from-focus method or the shape-from-shading method. Depth estimation using neural networks is also conceivable in principle. In the event that the camera is a stereo camera, the second sensor information can also be directly three-dimensional information, i.e. also have depth information for some of the pixels or for each pixel of the image. From this second sensor information, a second three-dimensional representation of environment information is generated. In particular, this can be a 3D point cloud. In the event that multiple sensors 3 of the second sensor type are used, the second three-dimensional representation of environment information can be generated on the basis of sensor information from multiple or all of these sensors 3.

Preferably, the vehicle 1 also comprises at least one sensor 4 of a third sensor type, which is a LIDAR sensor. Therefore, the third sensor type is based on the LIDAR principle. The sensor 4 can be provided, for example, in the roof area of the vehicle 1. It is understood that multiple sensors 4 of the third sensor type can be provided so as to be distributed over the vehicle 1. The at least one sensor 4 of the third sensor type generates third sensor information. This is, for example, the raw information provided by a LIDAR sensor. From this third sensor information, a third three-dimensional representation of environment information is generated unless already provided by the third sensor information. In particular, this can be a 3D point cloud. In the case that multiple sensors 4 of the third sensor type are used, the third three-dimensional representation of environment information can be generated on the basis of sensor information from multiple or all of these sensors 4.

Moreover, the vehicle further comprises a computing unit 5 configured to process further the data provided by the sensors 2, 3, 4. The computing unit can be a central computing unit, as shown in FIG. 1, or a number of decentralized computing units can be provided so that subtasks of the below described method are carried out so as to be distributed over a plurality of computing units.

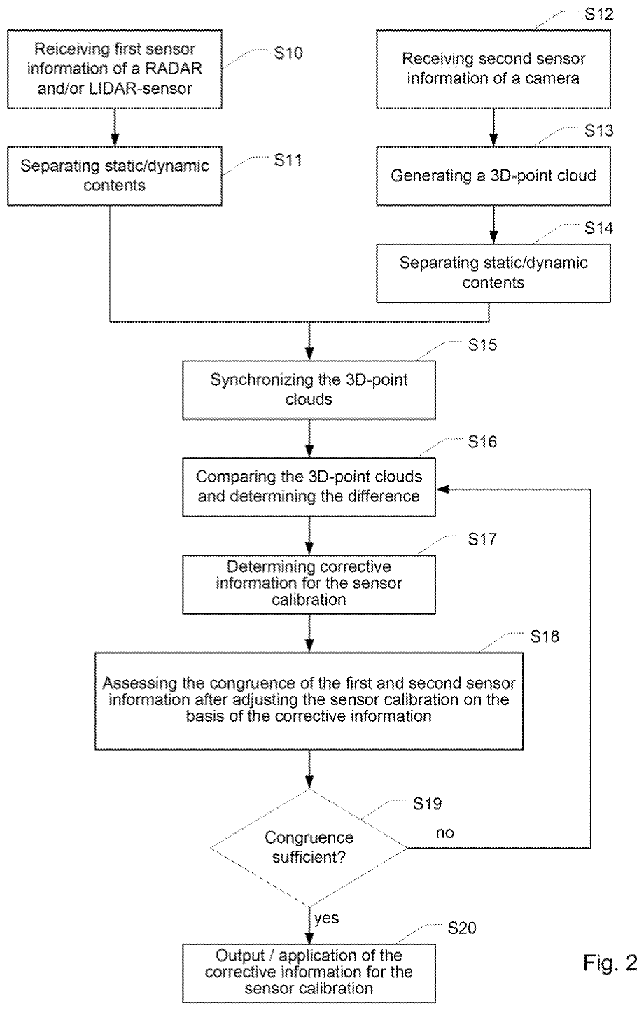

FIG. 2 shows a flow chart illustrating the method steps of the method for calibrating sensor information of different sensors 2, 3, 4 relative to one another.

In step S10, sensor information of at least one radar sensor and/or at least one LIDAR sensor is received. If radar and LIDAR sensors are present, sensor information is first provided separately for each type of sensor.

If these sensors do not already provide a three-dimensional representation of environment information, in particular a 3D point cloud, one is formed from the sensor information. If radar and LIDAR sensors are present, a three-dimensional representation of environment information, in particular a 3D point cloud, is provided separately for each sensor type. The 3D point clouds can be formed by sensor information from a single sensor or by merging sensor information from multiple sensors of the same sensor type.

Preferably, in step S11, the 3D point cloud obtained from the sensor information of the radar sensor and—if present—the 3D point cloud obtained from the sensor information of the LIDAR sensor are separated according to static and dynamic contents. In particular, this means that for each sensor type, a first 3D point cloud containing only static objects and a second 3D point cloud containing only moving objects are created in each case. It is thus possible to generate separate corrective information on the calibration parameters from static objects and moving objects.

In addition, second sensor information is received from a camera in step S12. From second sensor information, a 3D point cloud is generated in step S13.

For example, a three-dimensional reconstruction of the environment of the vehicle 1 is carried out by evaluating the temporally successive images of an image sequence of one or more cameras, for example by means of a structure-from-motion reconstruction method.

Preferably, a method disclosed in German patent application DE 10 2019 208 216 A1 is used. The disclosure of this patent application is made in its entirety the subject matter of the present disclosure. Preferably, according to the method, both a 3D reconstruction of the environment or output of a 3D point cloud, and a segmentation of moving objects are performed. It is thus possible to separate between moving and stationary objects in the image information provided by the at least one camera (S14). Furthermore, trajectories of the moving objects can be determined by means of the method, as well as the trajectory of the camera system with respect to the stationary surroundings. By knowing the movement of the objects it is also possible to correlate 3D point clouds of different sensor types, containing moving objects, to one another and in this way derive corrective information for the calibration. This simplifies, among other things, the synchronization and interpolation steps, which then also provide more accurate results.

After a separation of static and dynamic contents in the 3D point clouds, which were generated from sensor information of a radar sensor and/or a LIDAR sensor as well as from sensor information of a camera, has taken place, either the further method steps can be carried out only on the basis of 3D point clouds, which contain static objects, or separate 3D point clouds with in each case static or dynamic objects are generated and the further method runs are carried out separately for static and dynamic objects, i.e. both 3D point clouds with static objects and 3D point clouds with dynamic objects are compared and used to generate the corrective information for the sensor calibration. Therefore, the below described steps can be carried out in parallel for 3D point clouds with dynamic objects and 3D point clouds with static objects.

Steps S10/S11 and S12/S13/S14, i.e. the processing of the sensor information provided by the radar sensor or the LIDAR sensor and the sensor information provided by the camera can be carried out at least partially in parallel.

In step S15, the 3D point clouds are preferably synchronized with one another in such a way that they can become checkable for congruence. On the one hand, this can be a temporal synchronization. The 3D point clouds of the respective sensor types can be generated at different times so that the surroundings information in the 3D point clouds is locally offset from one another due to the movement of the vehicle. This offset can be corrected by synchronizing the 3D point clouds with respect to time. In addition, it is possible that intermediate information is calculated from a plurality of 3D point clouds that follow one another in time, for example by means of interpolation, in order to compensate for the temporal offset between the 3D point clouds of the respective sensor types.

Subsequently, in step S16, the 3D point clouds are compared with one another and the differences between the 3D point clouds are determined. For example, the points corresponding to one another in the point clouds to be compared, i.e. points that represent the same areas of a scene of the surroundings, can be compared to one another and the distances between these points or their local offset from one another can be determined. Therefore, it can be determined in step S18, which calibration inaccuracy exists between the sensors of the vehicle assistance system and which calibration parameters have to be changed (e.g. linear offset or difference due to a twisted sensor).

Subsequently, in step S18, the corrective information is applied, i.e. after a modification of the calibration parameters on the basis of the corrective information, the 3D point clouds are checked again for congruence and this congruence is assessed.

Subsequently, a decision is made in step S19 whether sufficient congruence has been achieved. If not, steps S16 to S19 are repeated. A minimization procedure with linear gradient descent, for example an iterative closest point method (ICP method), can be carried out.

When a sufficient congruence between the 3D point clouds has been achieved, the output of the corrective information on the calibration parameters of the sensors and/or a use thereof for sensor calibration is carried out in step S20.

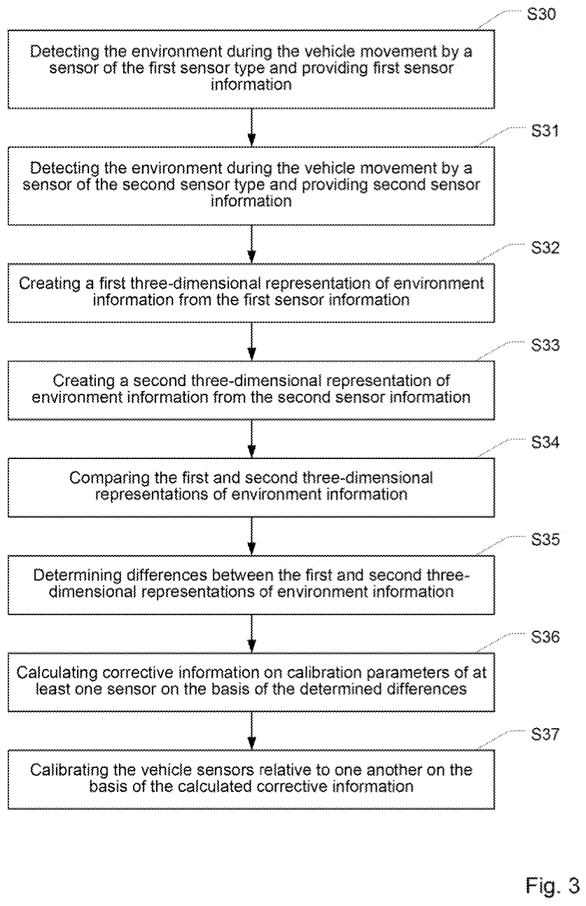

FIG. 3 shows a flow chart which makes clear the steps of a method for the online calibration of sensor information from sensors of a vehicle.

First, the environment is detected during the vehicle movement by at least one sensor of the first sensor type. Moreover, first sensor information is provided by this sensor of the first sensor type (S30).

In addition, the environment is detected during the vehicle movement by at least one sensor of the second sensor type. In this connection, second sensor information is provided by this sensor of the second sensor type (S31). Steps S31 and S32 are executed simultaneously or at least temporarily overlapping in time.

Subsequently, a first three-dimensional representation of environment information is created from the first sensor information (S32).

Simultaneously with step S32 or at least temporally overlapping, a second three-dimensional representation of environment information is generated from the second sensor information (S33).

Then, the first and second three-dimensional representations of environment information or information derived therefrom are compared with one another (S34). In this context, “derived information” means any information that can be obtained from the first or second three-dimensional representation by modification, for example by filtering, restriction to stationary or non-stationary objects, etc.

On the basis of the comparison result, differences between the first and second three-dimensional representations of environment information or information derived therefrom are determined (S35).

On the basis of the determined differences, corrective information for calibration parameters of at least one sensor is calculated (S36). Finally, the sensors of the vehicle are calibrated relative to one another on the basis of the calculated corrective information (S37). This means in particular that the position or orientation of the sensors on the vehicle is not modified, but an indirect calibration is performed by modifying the 3D point clouds on the basis of the corrective information.

The invention has been described above using exemplary embodiments. It is understood that numerous modifications as well as variations are possible without leaving the scope of protection defined by the claims.

### LIST OF REFERENCE SIGNS

1 vehicle
2 sensor
3 sensor
4 sensor
5 computing unit

1. A method for calibrating sensor information of a vehicle, wherein the vehicle comprises at least one sensor of a first sensor type and at least one sensor of a second sensor type which is different from the first sensor type, the method comprising the following steps:
detecting the environment during the movement of the vehicle by at least one sensor of the first sensor type and providing first sensor information by the at least one sensor of the first sensor type;
detecting the environment during the movement of the vehicle by at least one sensor of the second sensor type and providing second sensor information by the at least one sensor of the second sensor type;
creating a first three-dimensional representation of environment information from the first sensor information;
creating a second three-dimensional representation of environment information from the second sensor information;
comparing the first and second three-dimensional representations of environment information or information derived therefrom;
determining differences between the first and second three-dimensional representations of environment information or information derived therefrom;
calculating corrective information on calibration parameters of at least one sensor based on the determined differences;
calibrating the sensors of the vehicle relative to one another based on the calculated corrective information.

2. The method according to claim 1, wherein the first and second three-dimensional representations of environment information are discrete-time information, and wherein, prior to the first and second three-dimensional representations of environment information or information derived therefrom are compared, the information is synchronized with respect to one another with regard to time.

3. The method according to claim 1, wherein the first and second three-dimensional representations of environment information are discrete-time information, and in that, prior to the first and second three-dimensional representations of environment information or information derived therefrom are compared, an interpolation of information between two time steps of the discrete-time information is carried out.

4. The method according to claim 1, wherein in each case first and second three-dimensional representations of environment information which reflect the vehicle surroundings at the same time are compared with one another, and differences between these first and second three-dimensional representations of environment information are used to calculate the corrective information.

5. The method according to claim 1, wherein the calculation of corrective information on calibration parameters is carried out iteratively, namely in such a way that, in a plurality of iteration steps, in each case at least one first and second three-dimensional representations of environment information which reflect the vehicle surroundings at the same time are compared with one another, corrective information is calculated and, after the application of the corrective information to the calibration parameters of at least one sensor, information about congruence of the first and second three-dimensional representations of environment information is determined.

6. The method according to claim 5, wherein in the successive iteration steps the corrective information is iteratively changed in such a way that congruence error between the first and second three-dimensional representations of environment information is reduced.

7. The method according to claim 6, wherein a minimization method or an optimization method is used to reduce the congruence error.

8. The method according to claim 1, wherein the corrective information on calibration parameters is calculated by a plurality of first and second three-dimensional representations of environment information determined at different points in time in such a way that a plurality of pairs of first and second three-dimensional representations of environment information is compared with one another and corrective information is calculated, the environment information of a pair each reflecting the vehicle surroundings at the same point in time.

9. The method according to claim 1, wherein the sensor of the first sensor type is a camera.

10. The method according to claim 9, wherein the camera is a monocular camera and wherein from the image information provided by the camera, three-dimensional representations of environment information are calculated from single images or a sequence of temporally successive two-dimensional images.

11. The method according to claim 9 wherein, based on a sequence of temporally successive image information of at least one camera, there is a segmentation of moving objects contained in the image information and an estimation of three-dimensional structure and relative movements of the segmented objects and stationary surroundings.

12. The method according to claim 1, wherein the sensor of the second sensor type is a radar sensor or a LIDAR sensor.

13. The method according to claim 1, wherein moving objects are filtered out of the first and second three-dimensional representations of environment information so that the calculation of the corrective information is carried out exclusively on the basis of stationary objects.

14. The method according to claim 1, wherein the corrective information is calculated on the basis of based on a comparison of first and second three-dimensional representations of environment information containing only stationary objects and based on a comparison of first and second three-dimensional representations of environment information containing only moving objects.

15. A driver assistance system for a vehicle having a sensor of a first sensor type and at least one sensor of a second sensor type which is different from the first sensor type, wherein the driver assistance system is configured to carry out the following steps:
detecting the environment during movement of the vehicle by at least one sensor of the first sensor type and providing first sensor information by the at least one sensor of the first sensor type;
detecting the environment during the movement of the vehicle by at least one sensor of the second sensor type and providing second sensor information by the at least one sensor of the second sensor type;
creating a first three-dimensional representation of environment information from the first sensor information;
creating a second three-dimensional representation of environment information from the second sensor information;
comparing the first and second three-dimensional representations of environment information or information derived therefrom;
determining differences between the first and second three-dimensional representations of environment information or information derived therefrom;
calculating corrective information on calibration parameters of at least one sensor based on the determined differences;
calibrating the sensors of the vehicle relative to one another based on the calculated corrective information.
